(19) United States
(12) Patent Application Publication
(10) Pub. No.: US 2026/0211569 A1
(43) Pub. Date: Jul. 23, 2026

(54) MEMORY MANAGEMENT METHOD AND MEMORY STORAGE DEVICE

(71) Applicant: Hefei Kaimeng Technology Co., Ltd., Anhui (CN)

(72) Inventors: HaoJie Qi, Anhui (CN); Tsung-Lin Wu, Anhui (CN); Qiao ZHU, Anhui (CN); Zhi WANG, Anhui (CN); Wei Zhong, Anhui (CN); Dongsheng Guan, Anhui (CN)

(73) Assignee: Hefei Kaimeng Technology Co., Ltd., Anhui (CN)

(21) Appl. No.: 19/401,245

(22) Filed: Nov. 25, 2025

(30) Foreign Application Priority Data
Jan. 23, 2025 (CN) 202510110506.6

(51) Int. Cl. G06F 3/06

(52) U.S. Cl. CPC G06F 3/0635; G06F 3/0613; G06F 3/0679

(57) ABSTRACT

The invention provides a memory management method and a memory storage device for a rewritable non-volatile memory module including a plurality of memory submodules. The method includes: respectively obtaining a plurality of load values of a plurality of command queues corresponding to the plurality of memory submodules; selecting a first command queue from a plurality of command queues according to a plurality of load values, wherein the first command queue corresponds to a first memory submodule in the plurality of memory submodules; and pushing a first pending command corresponding to the first memory submodule in pending commands to the first command queue. As a result, the command push probability of each of the memory submodules is balanced according to the load value, thereby solving the issue of load imbalance caused by uneven distribution of recovered data or read-write conflicts with the host.

### CROSS-REFERENCE TO RELATED APPLICATION

This application claims the priority benefit of China application serial no. 202510110506.6 filed on Jan. 23, 2025. The entirety of the above patent application is hereby incorporated by reference herein and made a part of this specification.

### BACKGROUND OF THE INVENTION

### Field of the Invention

The invention relates to the field of storage techniques, and in particular to a memory management method and a memory storage device.

### Description of Related Art

Flash memory is a non-volatile memory widely used in electronic equipment such as memory cards, solid-state drives, and portable multimedia players.

Currently, memories typically adopt multi-channel, multi-memory dies and read and write data in an interleaved read/write mode to improve the overall throughput of the memory end. However, in some scenarios, load imbalance may occur among a plurality of dies, affecting the efficiency of flash interleave.

### SUMMARY OF THE INVENTION

The invention provides a single-buffer queue memory management method and a memory storage device balancing the command push probability of each memory submodule via the load value, thereby solving the issue of load imbalance caused by uneven distribution of recovered data or read-write conflicts with the host in a garbage collection scenario.

In an exemplary embodiment of the invention, a memory management method is provided for a rewritable non-volatile memory module, the rewritable non-volatile memory module including a plurality of memory submodules, including: obtaining a plurality of load values of a plurality of command queues corresponding to the plurality of memory submodules respectively; selecting a first command queue from the plurality of command queues according to the plurality of load values, wherein the first command queue corresponds to the first memory submodule; and pushing a first pending command corresponding to the first memory submodule in pending commands to the first command queue.

In an exemplary embodiment of the invention, a memory storage device is provided, including a connection interface unit, a rewritable non-volatile memory module, and a memory control circuit unit. The connection interface unit is configured to be electrically connected to a host system. The rewritable non-volatile memory module includes a plurality of memory submodules. The memory control circuit unit is electrically connected to the connection interface unit and the rewritable non-volatile memory module. In particular, the memory control circuit unit is configured to obtain a plurality of load values of a plurality of command queues corresponding to the plurality of memory submodules respectively. The memory control circuit unit is configured to select a first command queue from the plurality of command queues according to the plurality of load values, wherein the first command queue corresponds to the first memory submodule. The memory control circuit unit is configured to push a first pending command corresponding to the first memory submodule in pending commands to the first command queue.

In an exemplary embodiment of the invention, a memory control circuit unit is provided to control a rewritable non-volatile memory module. The memory control circuit unit includes a host interface, a memory interface, and a memory management circuit. The host interface is configured to be electrically connected to a host system. The memory interface is configured to be electrically connected to the rewritable non-volatile memory module, wherein the rewritable non-volatile memory module includes a plurality of memory submodules. The memory management circuit is electrically connected to the host interface and the memory interface. In particular, the memory management circuit is configured to obtain a plurality of load values of a plurality of command queues corresponding to the plurality of memory submodules respectively. The memory management circuit is configured to select a first command queue from the plurality of command queues according to the plurality of load values, wherein the first command queue corresponds to a first memory submodule in the plurality of memory submodules. The memory management circuit is configured to push a first pending command corresponding to the first memory submodule in pending commands to the first command queue.

Based on the above, the invention provides a memory management method and a memory storage device that may determine the priority of pushing to the command queue according to the time needed to execute all commands in each command queue as the initial load value corresponding to the command queue. The command queue with a small load gets more command pushing opportunities, thereby ensuring the load balance of all command queues, thereby achieving flash interleave under the condition of load balance of each command queue, effectively improving the throughput and the efficiency of data processing.

In order to make the above features and advantages of the invention more clearly understood, embodiments are given below with reference to the accompanying drawings for detailed description.

### BRIEF DESCRIPTION OF THE DRAWINGS

The accompanying drawings are included to provide a further understanding of the invention, and are incorporated into and constitute a part of this specification. The drawings illustrate the embodiments of the invention and, together with the description, serve to explain the principles of the invention.

FIG. 1 is a schematic diagram of a host system, a memory storage device, and an input/output (I/O) device shown according to an exemplary embodiment of the invention.

FIG. 2 is a schematic diagram of a host system, a memory storage device, and an I/O device shown according to another exemplary embodiment of the invention.

FIG. 3 is a schematic diagram of a host system and a memory storage device shown according to another exemplary embodiment of the invention.

FIG. 4 is a schematic block diagram of a memory storage device shown according to an exemplary embodiment of the invention.

FIG. 5 is a schematic block diagram of a memory control circuit unit shown according to an exemplary embodiment of the invention.

FIG. 6 is a schematic block diagram of a rewritable non-volatile memory module shown according to an exemplary embodiment of the invention.

FIG. 7 is a flowchart of a memory management method shown according to an exemplary embodiment of the invention.

FIG. 8 is a schematic diagram of selecting a command queue according to a load value to push a command shown according to an exemplary embodiment of the invention.

### DESCRIPTION OF THE EMBODIMENTS

Reference will now be made in detail to exemplary embodiments of the invention, and examples of the exemplary embodiments of the invention are illustrated in the accompanying drawings. Whenever possible, the same reference numerals are used in the drawings and the description to refer to the same or like parts.

The ordinal numbers used in the specification and the claims of the present application, such as terms such as “first” and “second”, are used to modify elements. They do not themselves mean or represent any previous ordinal numbers of the element or elements, nor do they represent the order of one element and another element, or the order in the manufacturing method. The use of these ordinal numbers is only used to clearly distinguish an element having a certain name from another element having the same name. The claims and the specification may not use the same terms. Accordingly, the first member in the specification may be the second member in the claims. It should be noted that the following embodiments may replace, reorganize, or mix the technical features in several different embodiments to implement other embodiments without departing from the spirit of the disclosure.

In general, a memory storage device (also known as a memory storage system) includes a rewritable non-volatile memory module and a controller (also known as a control circuit). Typically, a memory storage device is used in conjunction with a host system so that the host system may write data to the memory storage device or read data from the memory storage device.

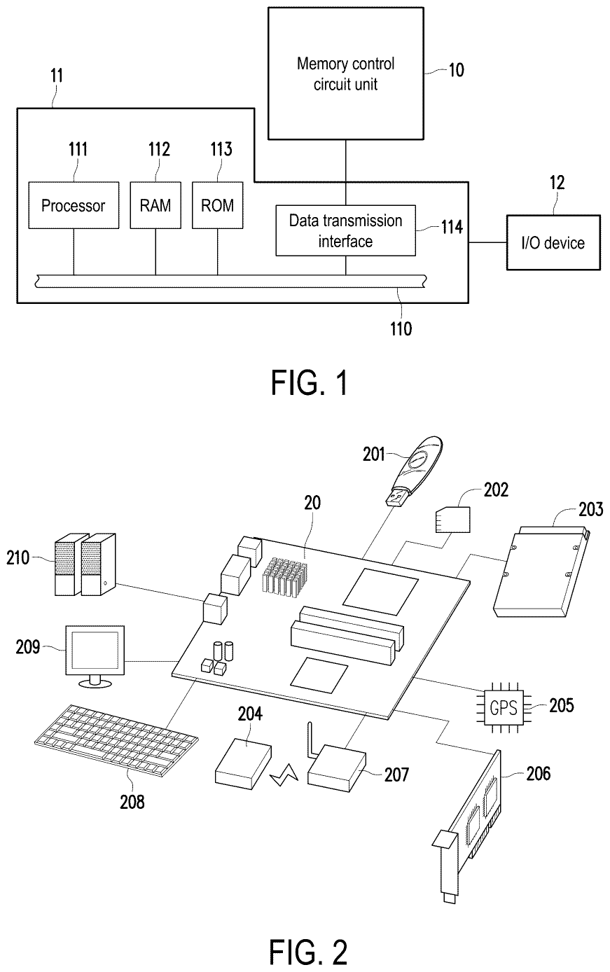

FIG. 1 is a schematic diagram of a host system, a memory storage device, and an input/output (I/O) device shown according to an exemplary embodiment of the invention. FIG. 2 is a schematic diagram of a host system, a memory storage device, and an I/O device shown according to another exemplary embodiment of the invention.

Referring to FIG. 1 and FIG. 2, a host system 11 generally includes a processor 111, a random-access memory (RAM) 112, a read-only memory (ROM) 113, and a data transmission interface 114. The processor 111, the random-access memory 112, the read-only memory 113, and the data transmission interface 114 are all electrically connected to a system bus 110.

In the present exemplary embodiment, the host system 11 is electrically connected to the memory storage device 10 via the data transmission interface 114. For example, the host system 11 may store data to the memory storage device 10 or read data from the memory storage device 10 via the data transmission interface 114. In addition, the host system 11 is electrically connected to an I/O device 12 via the system bus 110. For example, the host system 11 may transmit an output signal to the I/O device 12 or receive an input signal from the I/O device 12 via the system bus 110.

In the present exemplary embodiment, the processor 111, the random-access memory 112, the read-only memory 113, and the data transmission interface 114 may be disposed on a motherboard 20 of the host system 11. The number of the data transmission interface 114 may be one or a plurality. Via the data transmission interface 114, the mainboard 20 may be electrically connected to the memory storage device 10 via a wired or wireless manner. The memory storage device 10 may be, for example, a USB flash drive 201, a memory card 202, a solid-state drive (SSD) 203, or a wireless memory storage device 204. The wireless memory storage device 204 may be, for example, a Near-Field Communication (NFC) memory storage device, a WiFi memory storage device, a Bluetooth memory storage device, or a low-power Bluetooth memory storage device (e.g., iBeacon), or other memory storage devices based on various wireless communication techniques. In addition, the motherboard 20 may also be electrically connected to various I/O devices such as a global positioning system (GPS) module 205, a network adapter 206, a wireless transmission device 207, a keyboard 208, a display 209, and a speaker 210 via the system bus 110. For example, in an exemplary embodiment, the motherboard 20 may access the wireless memory storage device 204 via the wireless transmission device 207.

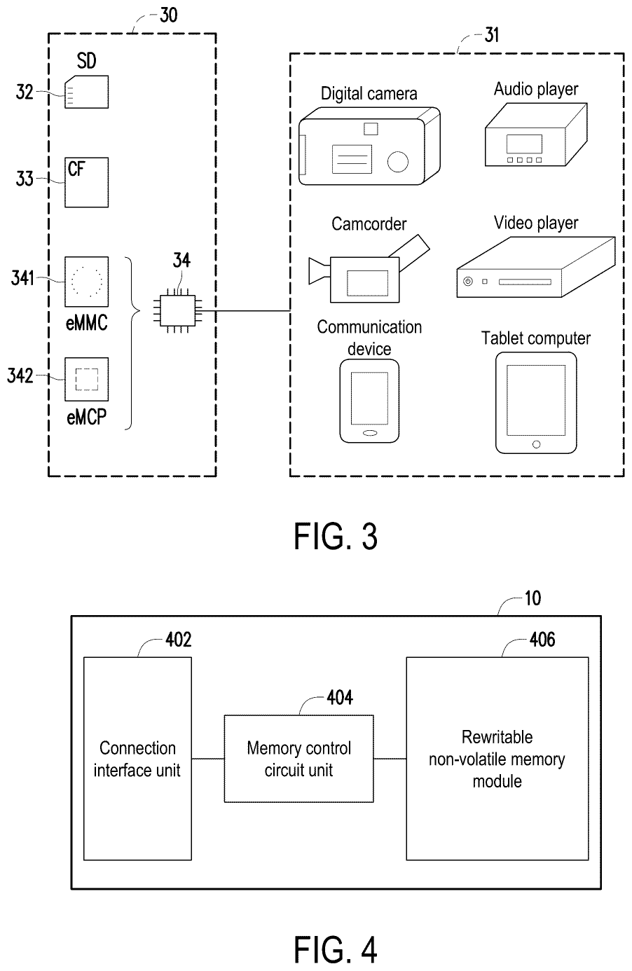

In an exemplary embodiment, the host system mentioned herein is substantially any system that may cooperate with a memory storage device to store data. Although the host system is described as a computer system in the above exemplary embodiment, FIG. 3 is a schematic diagram of a host system and a memory storage device shown according to another exemplary embodiment of the invention. Referring to FIG. 3, in another exemplary embodiment, the host system 31 may also be a system such as a digital camera, a video camera, a communication device, an audio player, a video player, or a tablet computer, and the memory storage device 30 may be various non-volatile memory storage devices used therein such as a Secure Digital (SD) card 32, a Compact Flash (CF) card 33, or an embedded storage device 34. The embedded storage device 34 includes various types of embedded storage devices such as an embedded Multi Media Card (eMMC) 341 and/or an embedded Multi Chip Package (eMCP) storage device 342 electrically connecting a memory module directly to a substrate of a host system.

FIG. 4 is a schematic block diagram of a memory storage device shown according to an exemplary embodiment of the invention.

Referring to FIG. 4, the memory storage device 10 includes a connection interface unit 402, a memory control circuit unit 404, and a rewritable non-volatile memory module 406.

The connection interface unit 402 is configured to electrically connect the memory storage device 10 to the host system 11. In the present exemplary embodiment, the connection interface unit 402 complies with the Peripheral Component Interconnect Express (PCI Express) standard and is compatible with the Non-Volatile Memory Express (NVM express) interface standard. Specifically, the NVM express standard is a protocol for communication between a host system and a memory device defining the cache interface, the instruction set, and the function set between the controller of the memory storage device and the operating system of the host system. By optimizing the interface standard of the memory storage device, the data access speed and the data transmission rate of the memory storage device based on the PCIe interface is promoted. However, in another exemplary embodiment, the connection interface unit 402 may also comply with other suitable standards. In addition, the connection interface unit 402 and the memory control circuit unit 404 may be packaged in one chip, or the connection interface unit 402 is disposed outside a chip including the memory control circuit unit 404.

The memory control circuit unit 404 is configured to execute a plurality of logic gates or control instructions implemented in hardware form or firmware form and perform operations such as writing, reading, and erasing data in the rewritable non-volatile memory module 406 according to instructions from the host system 11.

The rewritable non-volatile memory module 406 is electrically connected to the memory control circuit unit 404 and configured to store data written by the host system 11. The rewritable non-volatile memory module 406 may be a single-level cell (SLC) NAND memory module (i.e., a memory module in which one memory cell may store one bit), a multi-level cell (MLC) NAND memory module (i.e., a memory module in which one memory cell may store two bits), a triple-level cell (TLC) NAND memory module (i.e., a memory module in which one memory cell may store three bits), other memory modules, or other memory modules having the same characteristics.

Each memory cell in the rewritable non-volatile memory module 406 stores one or a plurality of bits by changing the voltage (hereinafter also referred to as the threshold voltage). Specifically, there is a charge trapping layer between the control gate and the channel of each memory cell. By applying a write voltage to the control gate, the number of electrons of the charge trapping layer may be changed, thereby changing the threshold voltage of the memory cell. The operation of changing the threshold voltage of a memory cell is also called “writing data into the memory cell” or “programming the memory cell.” As the threshold voltage is changed, each memory cell in the rewritable non-volatile memory module 406 has a plurality of storage states. By applying a read voltage, the storage state of one memory cell may be determined, thereby obtaining one or a plurality of bits stored in the memory cell.

In the present exemplary embodiment, the memory cells of the rewritable non-volatile memory module 406 form a plurality of physical programming units, and the physical programming units form a plurality of physical erase units. Specifically, the storage units on the same character line may form one or a plurality of physical programming units. In the case that each storage unit may store two bits or more, the physical programming units on the same character line may be classified into at least lower physical programming units and upper physical programming units. For example, the least significant bit (LSB) of a memory cell belongs to the lower physical programming unit, and the most significant bit (MSB) of a memory cell belongs to the upper physical programming unit. In general, in an MLC NAND memory, the writing speed of the lower physical programming unit is faster than the writing speed of the upper physical programming unit, and/or the reliability of the lower physical programming unit is higher than the reliability of the upper physical programming unit.

In the present exemplary embodiment, the physical programming unit is the smallest unit of programming. That is, the physical programming unit is the smallest unit of writing data. For example, the physical programming unit is a physical page or a physical sector. In the case that the physical programming units are physical pages, the physical programming units usually include a data bit area and a redundancy bit area. The data bit area includes a plurality of physical sectors configured to store user data, and the redundancy bit area is configured to store system data (e.g., management data such as an error correction code). In the present exemplary embodiment, the data bit area includes 32 physical sectors, and the size of one physical sector is 512 bytes (B). However, in other exemplary embodiments, the data bit area may also include 8, 16, or a greater or lesser number of physical sectors, and the size of each physical sector may also be larger or smaller. Moreover, the physical erase unit is the minimum unit of erase. That is, each physical erase unit contains a minimum number of erased memory cells. For example, the physical erase unit is a physical block.

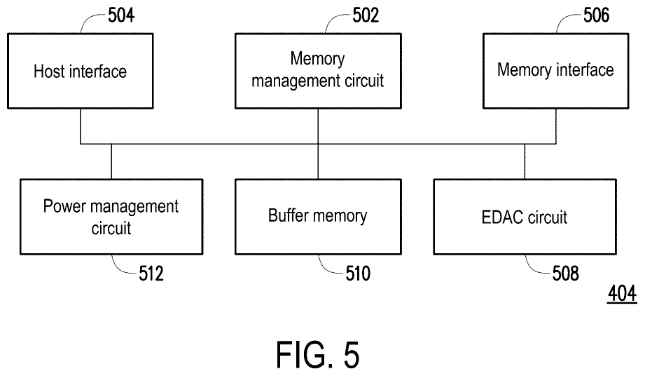

FIG. 5 is a schematic block diagram of a memory control circuit unit shown according to an exemplary embodiment of the invention.

Referring to FIG. 5, the memory control circuit unit 404 includes a memory management circuit 502, a host interface 504, and a memory interface 506.

The memory management circuit 502 is configured to control the overall operation of the memory control circuit unit 404. Specifically, the memory management circuit 502 has a plurality of control instructions, and when the memory storage device 10 is in operated, the control instructions are executed to perform an operation such as writing, reading, and erasing data. The following description of the operation of the memory management circuit 502 is equivalent to the description of the operation of the memory control circuit unit 404.

In the present exemplary embodiment, the control instructions of the memory management circuit 502 are implemented in firmware form. For example, the memory management circuit 502 has a microprocessor unit (not shown) and a read-only memory (not shown), and the control instructions are recorded in the read-only memory. When the memory storage device 10 is in operation, the control instructions are executed by the microprocessor unit to execute an operation such as writing, reading, and erasing data.

In another exemplary embodiment, the control instructions of the memory management circuit 502 may also be stored in a specific area of the rewritable non-volatile memory module 406 (e.g., a system area in the memory module dedicated to storing system data) in the form of program codes. In addition, the memory management circuit 502 has a microprocessor unit (not shown), a read-only memory (not shown), and a random-access memory (not shown). In particular, the read-only memory has a boot code, and when the memory control circuit unit 404 is enabled, the microprocessor unit first executes the boot code to load the control instructions stored in the rewritable non-volatile memory module 406 into the random-access memory of the memory management circuit 502. Then, the microprocessor unit executes the control instructions to perform an operation such as writing, reading, and erasing data.

Furthermore, in another exemplary embodiment, the control instructions of the memory management circuit 502 may also be implemented in a hardware form. For example, the memory management circuit 502 includes a microcontroller, a storage unit management circuit, a memory write circuit, a memory read circuit, a memory erase circuit, and a data processing circuit. The storage unit management circuit, the memory writing circuit, the memory read circuit, the memory erase circuit, and the data processing circuit are electrically connected to the microcontroller. The storage unit management circuit is configured to manage the storage units or groups of storage units of the rewritable non-volatile memory module 406. The memory write circuit is configured to issue a write command sequence to the rewritable non-volatile memory module 406 to write data into the rewritable non-volatile memory module 406. The memory read circuit is configured to issue a read command sequence to the rewritable non-volatile memory module 406 to read data from the rewritable non-volatile memory module 406. The memory erase circuit is configured to issue an erase command sequence to the rewritable non-volatile memory module 406 to erase data from the rewritable non-volatile memory module 406. The data processing circuit is configured to process data to be written into the rewritable non-volatile memory module 406 and data to be read from the rewritable non-volatile memory module 406. The write command sequence, the read command sequence, and the erase command sequence may each include one or a plurality of program codes or scripts and are configured to instruct the rewritable non-volatile memory module 406 to execute a corresponding operation such as writing, reading, and erasing. In an exemplary embodiment, the memory management circuit 502 may also issue other types of instruction sequences to the rewritable non-volatile memory module 406 to instruct the rewritable non-volatile memory module 406 to execute a corresponding operation.

The host interface 504 is electrically connected to the memory management circuit 502 and configured to receive and identify instructions and data sent by the host system 11. That is, the instructions and the data sent by the host system 11 are transmitted to the memory management circuit 502 via the host interface 504. In the present exemplary embodiment, the host interface 504 is compatible with the PCI Express standard. However, it should be understood that the invention is not limited thereto, and the host interface 504 may also be compatible with the PATA standard, IEEE 1394 standard, SATA standard, USB standard, SD standard, UHS-I standard, UHS-II standard, MS standard, MMC standard, eMMC standard, UFS standard, CF standard, IDE standard, or other suitable data transmission standards.

The memory interface 506 is electrically connected to the memory management circuit 502 and configured to access the rewritable non-volatile memory module 406. That is, the data to be written into the rewritable non-volatile memory module 406 is converted into a format acceptable to the rewritable non-volatile memory module 406 via the memory interface 506. Specifically, in the case that the memory management circuit 502 is to access the rewritable non-volatile memory module 406, the memory interface 506 transmits a corresponding instruction sequence. For example, the instruction sequences may include a write instruction sequence indicating writing data, a read instruction sequence indicating reading data, an erase instruction sequence indicating erasing data, and corresponding instruction sequences configured to indicate various memory operations (e.g., changing a read voltage level or executing a garbage collection operation, etc.). The command sequences are generated by the memory management circuit 502, for example, and transmitted to the rewritable non-volatile memory module 406 via the memory interface 506. The command sequences may include one or a plurality of signals, or data on a bus. The signals or data may include scripts or program codes. For example, a read instruction sequence includes information such as a read identification code and a memory address.

In an exemplary embodiment, the memory control circuit unit 404 further includes an error detection and correction (EDAC) circuit 508, a buffer memory 510, and a power management circuit 512.

The EDAC circuit 508 is electrically connected to the memory management circuit 502 and configured to execute an EDAC operation to ensure data accuracy. Specifically, when the memory management circuit 502 receives a write instruction from the host system 11, the EDAC circuit 508 generates a corresponding error correcting code (ECC) and/or error detecting code (EDC) for the data corresponding to the write instruction, and the memory management circuit 502 writes the data corresponding to the write instruction and the corresponding ECC and/or EDC into the rewritable non-volatile memory module 406. Then, when the memory management circuit 502 reads data from the rewritable non-volatile memory module 406, the memory management circuit 502 simultaneously reads the ECC and/or the EDC corresponding to the data, and the EDAC circuit 508 executes an EDAC operation on the read data according to the ECC and/or EDC.

The buffer memory 510 is electrically connected to the memory management circuit 502 and configured to temporarily store data and instructions from the host system 11 or data from the rewritable non-volatile memory module 406. The power management circuit 512 is electrically connected to the memory management circuit 502 and configured to control the power of the memory storage device 10.

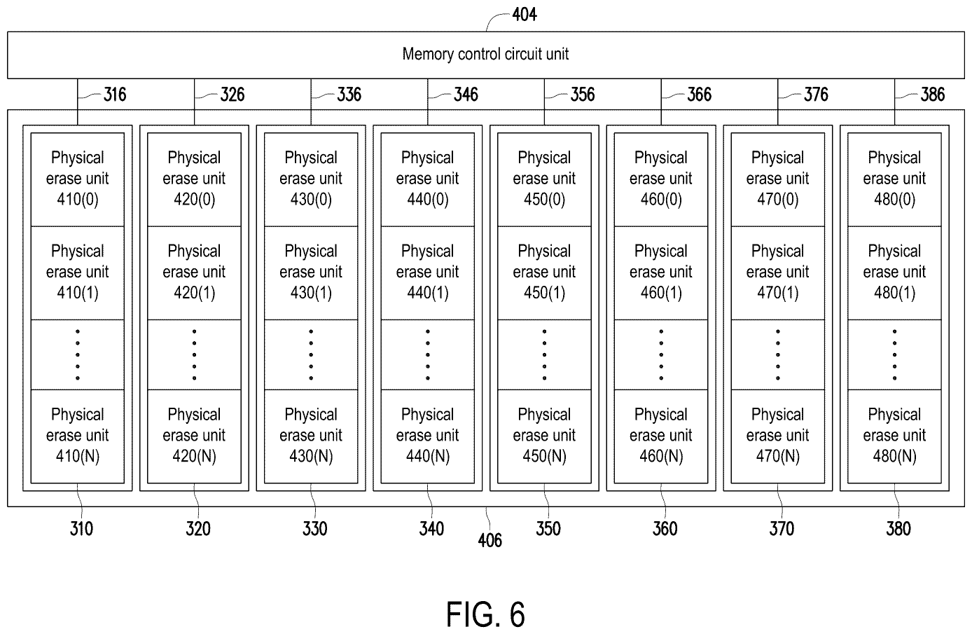

FIG. 6 is a schematic block diagram of a rewritable non-volatile memory module shown according to an exemplary embodiment of the invention.

The present application solution is illustrated using 8 memory submodules as an example. Please refer to FIG. 6. The rewritable non-volatile memory module 406 includes a first memory submodule 310, a second memory submodule 320, a third memory submodule 330, a fourth memory submodule 340, a fifth memory submodule 350, a sixth memory submodule 360, a seventh memory submodule 370, and an eighth memory submodule 380. For example, the first, second, third, fourth, fifth, sixth, seventh, and eighth memory submodules 310, 320, 330, 340, 350, 360, 370 and 380 are memory dies, respectively. The first memory submodule 310 has physical erase units 410 (0) to 410 (N). The second memory submodule 320 has physical erase units 420 (0) to 420 (N). The third memory submodule 330 has physical erase units 430 (0) to 430 (N). The fourth memory submodule 340 has physical erase units 440 (0) to 440 (N). The fifth memory submodule 350 has physical erase units 450 (0) to 450 (N). The sixth memory submodule 360 has physical erase units 460 (0) to 460 (N). The seventh memory submodule 370 has physical erase units 470 (0) to 470 (N). The eighth memory submodule 380 has physical erase units 480 (0) to 480 (N).

For example, the first, second, third, fourth, fifth, sixth, seventh and eighth memory submodules 310, 320, 330, 340, 350, 360, 370, and 380 are electrically connected to the memory control circuit unit 404 via independent data buses 316, 326, 336, 346, 356, 366, 376, and 386, respectively. Therefore, the memory management circuit 502 may write data to the first, second, third, fourth, fifth, sixth, seventh, and eighth memory submodules 310, 320, 330, 340, 350, 360, 370, and 380 via the data buses 316, 326, 336, 346, 356, 366, 376, and 386 in a parallel manner.

However, it should be understood that in another exemplary embodiment of the invention, the first, second, third, fourth, fifth, sixth, seventh, and eighth memory submodules 310, 320, 330, 340, 350, 360, 370 and 380 may also be electrically connected to the memory control circuit unit 404 via only one data bus. Here, the memory management circuit 502 may write data to the first, second, third, fourth, fifth, sixth, seventh, and eighth memory submodules 310, 320, 330, 340, 350, 360, 370, and 380 via a single data bus in an interleave manner.

It is worth mentioning that although the exemplary embodiment of the invention is described by taking the rewritable non-volatile memory module 406 including eight memory submodules as an example, the invention is not limited thereto. In other embodiments, the rewritable non-volatile memory module 406 may also include two, four, six, or ten memory submodules.

In the traditional mode, each memory submodule corresponds to a command queue, and the scheduling algorithm between command queues is usually a polling algorithm. When the load of each command queue is very balanced, the polling algorithm may better implement the flash interleave of the memory. For the mode of pushing the issued command to the command queue according to the order in which the host issues the command under the single buffer architecture, it may lead to certain scenarios, such as conflicts between a garbage collection (GC) operation and a read and write operation of the host system 11, causing a certain memory submodule to be blocked for a long time, while the commands corresponding to other memory submodules may not be pushed to the idle command queue due to the later issuance time, resulting in inability to execute. At this time, the efficiency of flash interleave is significantly reduced.

For example, when a GC operation is executed, recycled data needs to be read from eight memory submodules. In the case that the amount of recycled data distributed in each memory submodule is varied significantly, in the case that commands are pushed in the traditional order of command generation, the situation that a certain memory submodule is already full and other memory submodules are always idle may occur. The corresponding command may only be received and executed when the command corresponding to the memory submodule comes in the command push order, resulting in wasted memory resources due to unnecessary waiting.

Alternatively, in the case that data needs to be read and recycled from 8 memory submodules when a GC operation is executed, and at the same time, executing a host read and write operation requires operating a certain memory submodule, in the case that the traditional mode of pushing the issued command to the command queue according to the order in which the host issues the command is followed, the read command may be blocked by the read and write operation of the host system 11 when the GC operation is executed, thereby reducing the overall garbage collection efficiency.

Pushing the above command to the command queue in the order in which the command is sent or in the order in which the host sends the command is not beneficial to the overall command execution efficiency, resulting in a long waiting time of the command. Therefore, the present solution provides a memory management method to solve the above issue.

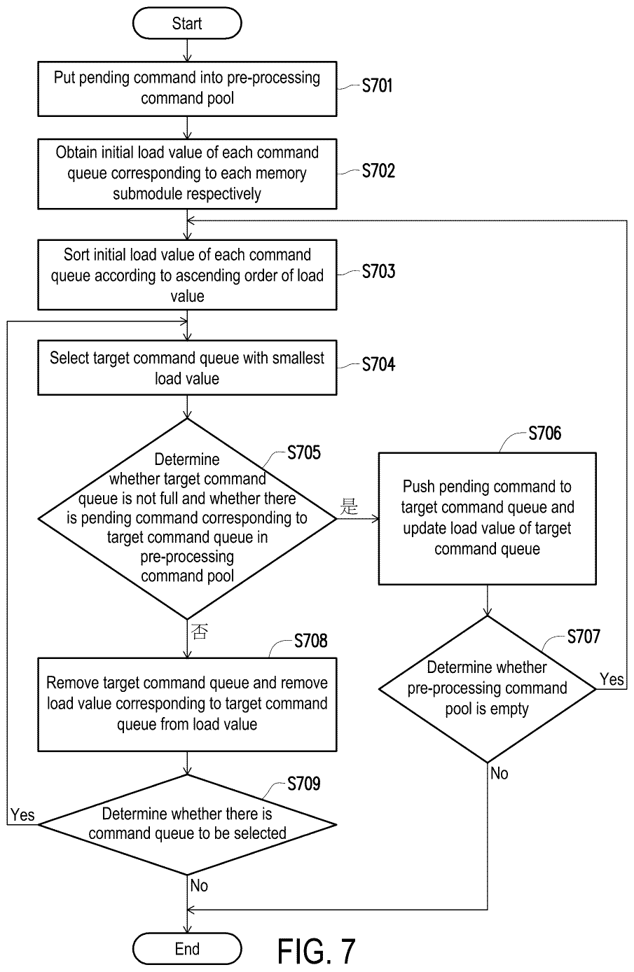

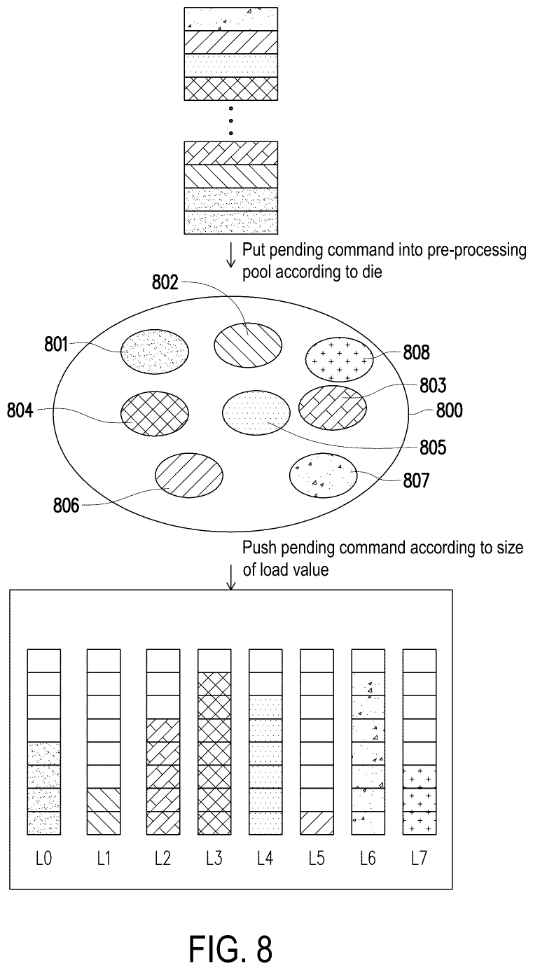

A memory management method of the invention is described in detail below by taking the rewritable non-volatile memory module 406 including eight memory submodules as an example and combining the embodiments of FIG. 7 and FIG. 8. Each process of the present method may be adjusted according to the implementation situation, and is not limited thereto.

FIG. 7 is a flowchart of a memory management method shown according to an exemplary embodiment of the invention. FIG. 8 is a schematic diagram of selecting a command queue according to a load value to push a command shown according to an exemplary embodiment of the invention.

Combining FIG. 7 and FIG. 8, in step S701, the memory management circuit 502 may place a pending command into a pre-processing command pool 800.

In an embodiment, the pending command may include a read command and a write instruction for a certain memory submodule issued by the host system 11, and a read command for the memory management circuit 502 to read recovered data of each memory submodule when a GC operation is executed, etc. The invention is not limited thereto. Furthermore, the status of the pre-processing command pool 800 is updated in real time, that is, a new pending command is added or a pending command in the pre-processing command pool 800 is removed.

As shown in FIG. 8, the pending commands may include pending commands corresponding to each memory submodule respectively. For example, the first pending command 801 in the pre-processing command pool 800 corresponds to the first memory submodule 310, the second pending command 802 corresponds to the second memory submodule 320, the third pending command 803 corresponds to the third memory submodule 330, the fourth pending command 804 corresponds to the fourth memory submodule 340, the fifth pending command 805 corresponds to the fifth memory submodule 350, the sixth pending command 806 corresponds to the sixth memory submodule 360, the seventh pending command 807 corresponds to the seventh memory submodule 370, and the eighth pending command 808 corresponds to the eighth memory submodule 380.

In step S702, the memory management circuit 502 obtains the initial load value of each command queue corresponding to each memory submodule respectively.

In an embodiment, pending commands may be classified into read commands, write commands, and erase commands according to command types. Specifically, since the execution time of commands of different command types is different, the weight may be set according to the ratio of the command execution time of each command type, or different priority weights may be set for different types of commands. In actual application, the weight may be set according to specific needs, and no specific limitation is made here.

The memory management circuit 502 may obtain the execution completion time of each command according to the command type of each command included in each command queue, and sum up the execution completion time of each command according to the weight of each command type as the load value or the initial load value of each command queue.

The following description is made by taking the calculation of the load value or the initial load value of a certain command queue (the first command queue and the second command queue) as an example. A similar approach may be applied to other command queues.

The memory management circuit 502 may obtain the load value or the initial load value of a command queue via the following equation 1. Equation 1 is as follows:

$$Ln - 1 = k 1 \times Tread + k 2 \times Tprog + k 3 \times Terase$$

wherein Ln−1 is the load value or the initial load value of the n-th command queue, k1 is the number of read commands in the n-th command queue, k2 is the number of write commands in the n-th command queue, k3 is the number of erase commands in the n-th command queue, Tread is the execution completion time of executing one read command, Tprog is the execution completion time of executing one write command, and Terase is the execution completion time of executing one erase command. In the calculation process here, the priority of each type of command is regarded as the same priority. In actual application, the corresponding priority weights may be respectively set according to specific needs.

In an embodiment, in the case that the first command queue includes two read commands, one write command, and one erase command, the execution completion time of each command is summed up according to the above equation 1 as the load value or the initial load value of the first command queue: L0=2×Tread+1×Tprog+1×Terase.

In another embodiment, in the case that the second command queue includes one read command and one write command, the execution completion time of each command is summed up according to the above equation 1 as the load value or the initial load value of the second command queue: L1=1×Tread+1×Tprog.

Thus, the memory management circuit 502 may obtain the initial load values L0, L1, L2, L3, L4, L5, L6, and L7 corresponding to the first, second, third, fourth, fifth, sixth, seventh, and eighth command queues respectively as shown in FIG. 8 via the above equation 1.

In step S703, the memory management circuit 502 may sort the initial load value of each command queue according to the ascending order of the load value.

In an embodiment, the memory management circuit 502 may sort the initial load value of each command queue in ascending order as L5, L1, L7, L0, L2, L4, L3, and L6. At this point, L5 has the smallest load value.

In step S704, the memory management circuit 502 selects a command queue with the smallest load value from each command queue as a target command queue to which the pending command is pushed.

In an embodiment, the memory management circuit 502 selects a target command queue with the smallest load value (L5) from each command queue, and the target command queue is the sixth command queue corresponding to the sixth memory submodule 360.

In step S705, the memory management circuit 502 may determine whether the target command queue (i.e., the sixth command queue) is not full and whether there is a pending command (i.e., the sixth processing command 806) corresponding to the target command queue in the pre-processing command pool 800.

Furthermore, in the case that the target command queue is full, the load value of the current memory submodule reached the maximum. Unless at least one command is dequeued from the target command queue, the pending command may not be pushed to the target command queue.

In an embodiment, the memory management circuit 502 may learn, via the model of the memory submodule, the threshold value of the number of commands that a target command queue corresponding to the memory submodule may include. When the number of commands included in the target command queue is greater than or equal to the threshold value, the memory management circuit 502 may determine that the target command queue is full; when the number of commands included in the target command queue is less than the threshold value, the memory management circuit 502 may determine that the target command queue is not full. The invention is not limited thereto.

In an embodiment, the threshold value is related to the model of the memory submodule.

When the target command queue is not full and there is a pending command corresponding to the target command queue in the pre-processing command pool 800, in step S706, the memory management circuit 502 may push the pending command corresponding to the target command queue to the target command queue and update the load value of the target command queue.

In the present embodiment, the target command queue is the sixth command queue. In the case that the sixth command queue is not full and there is the sixth pending command 806 corresponding to the sixth command queue in the pre-processing command pool 800, the memory management circuit 502 may push the sixth pending command 806 to the sixth command queue and update the load value of the sixth command queue. At this time, the updated load value L5′ corresponding to the sixth command queue is L5′=L5+1×T, wherein T is the execution completion time of the sixth pending command 806.

The above method determines the load value of each command queue corresponding to each memory submodule via the command execution time, selects the target command queue corresponding to the memory submodule for priority execution based on the load value, and pushes the command to the target command queue, so as to achieve the load of each command queue being in a relatively balanced state and improve the overall command processing efficiency.

In step S707, the memory management circuit 502 determines whether the pre-processing command pool 800 is empty.

When the pre-processing command pool 800 is empty, that is, when there is no pending command in the pre-processing command pool 800, the process ends.

When the pre-processing command pool 800 is not empty, that is, there are still pending commands in the pre-processing command pool 800, step S703 is repeated, the memory management circuit 502 may re-sort the updated load value of the target command queue and the initial load values of each command queue except the target command queue according to the ascending order of the load value, and continue to execute the subsequent process of reselecting the target command queue to push the pending commands until each command queue is full or the pre-processing command pool 800 is empty.

In the present embodiment, in the case that the target command queue is full and there is no pending command corresponding to the target command queue in the pending commands, or there is no corresponding GC operation for the memory submodule corresponding to the target command queue, in step S708, the memory management circuit 502 removes the target command queue from the command queue and removes the load value corresponding to the target command queue from the load value.

In an embodiment, in the case that the target command queue is full and there is no pending command corresponding to the target command queue in the pre-processing command pool 800 (for example, there is no garbage collection operation on the target memory submodule corresponding to the target command queue), the above steps S704, S705 and S706 are executed on the remaining memory submodules except the target memory submodule to facilitate the load of the command queue corresponding to each memory submodule to be in a relatively balanced state.

After the target command queue is removed from the command queue and the load value corresponding to the target command queue is removed from the load value, in step S709, the memory management circuit 502 determines whether there is a command queue to be selected.

In the case that the memory management circuit 502 determines that there is still a command queue to be selected, step S704 is repeated to continue selecting the command queue with the smallest load value from each command queue.

The above pushing of pending commands to the target command queue that is not full and has the smallest load value is conducive to ensuring that the load of each command queue corresponding to each memory submodule is relatively balanced, which not only improves the overall command processing performance, but also effectively avoids the situation in which a read and write operation of the host is performed and a GC operation is executed on the same memory submodule at the same time, resulting in the read command being blocked by the read and write operation of the host when the GC operation is executed, thereby reducing the overall garbage collection efficiency, and effectively solving the issue of load imbalance caused by uneven distribution of recovered data or read-write conflicts with the host.

In the case that the memory management circuit 502 determines that there is no command queue to be selected, each command queue is full, or the pre-processing command pool 800 is empty, and the process ends.

Based on the above, the invention provides a memory management method and a memory storage device that may use the time needed to execute all commands in each command queue as the load value corresponding to the command queue, thereby determining the priority of pushing to the command queue according to the load value of each command queue. The command queue with a small load gets more command pushing opportunities, thereby ensuring the load balance of all command queues, thereby achieving flash interleave under the condition of load balance of each command queue, effectively improving the throughput and the efficiency of data processing.

Via the description of the above implementation methods, those skilled in the art may clearly understand that the above embodiment methods may be implemented by means of software plus the desired general hardware platform, and of course may also be implemented by hardware, but in many cases the former is a better implementation method. Based on the understanding, the essential technical solution of the present application, or the part that contributes to the prior art, may be embodied in the form of a computer software product, and the computer software product is stored in one storage medium (such as ROM/RAM, disk, or CD-ROM) and includes a number of instructions configured to enable a terminal (may be a mobile phone, computer, server, or network equipment, etc.) to execute the methods described in each embodiment of the present application.

Lastly, it should be noted that the above embodiments are only used to illustrate the technical solutions of the invention, rather than to limit them. Although the invention has been described in detail with reference to the aforementioned embodiments, it should be understood by those skilled in the art that the technical solutions described in the aforementioned embodiments may be modified, or some or all of the technical features thereof may be replaced with equivalents. However, these modifications or replacements do not cause the essence of the corresponding technical solutions to deviate from the scope of the technical solutions of the embodiments of the invention.

What is claimed is:

1. A memory management method, for a rewritable non-volatile memory module, wherein the rewritable non-volatile memory module comprises a plurality of memory submodules, comprising:
obtaining a plurality of load values of a plurality of command queues corresponding to the plurality of memory submodules respectively;
selecting a first command queue from the plurality of command queues according to the plurality of load values, wherein the first command queue corresponds to a first memory submodule; and
pushing a first pending command corresponding to the first memory submodule in pending commands to the first command queue.

2. The memory management method according to claim 1, wherein the step of obtaining the plurality of load values of the plurality of command queues corresponding to the plurality of memory submodules respectively further comprises:
obtaining an execution completion time of each command according to a command type of each of the commands in each of the command queues;
summing up the execution completion time of each of the commands as the load value of each of the command queues.

3. The memory management method according to claim 1, wherein the step of selecting the first command queue from the plurality of command queues according to the plurality of load values, wherein the first command queue corresponds to the first memory submodule in the plurality of memory submodules further comprises:
sorting the plurality of load values according to an ascending order of the load values to obtain a sorting result; and
selecting the first command queue from the plurality of command queues according to the sorting result, wherein a first load value corresponding to the first command queue is smallest.

4. The memory management method according to claim 3, wherein after the step of selecting the first command queue from the plurality of command queues according to the sorting result, the method further comprises:
determining whether the first command queue is not full and whether there is the first pending command corresponding to the first command queue in the pending commands;
pushing the first pending command to the first command queue when the first command queue is not full and there is the first pending command corresponding to the first command queue in the pending commands.

5. The memory management method according to claim 3, wherein after the step of selecting the first command queue from the plurality of command queues according to the sorting result, the method further comprises:
determining whether the first command queue is not full and whether there is the first pending command corresponding to the first command queue in the pending commands;
removing the first command queue from the plurality of command queues and removing the first load value corresponding to the first command queue from the plurality of load values when the first command queue is full and/or there is no first pending command corresponding to the first command queue in the pending commands.

6. The memory management method according to claim 4, wherein the step of determining whether the first command queue is not full and whether there is the first pending command corresponding to the first command queue in the pending commands further comprises:
determining whether the first command queue is not full according to whether a number of commands in the first command queue is less than a threshold value.

7. The memory management method according to claim 5, wherein the step of determining whether the first command queue is not full and whether there is the first pending command corresponding to the first command queue in the pending commands further comprises:
determining whether the first command queue is not full according to whether a number of commands in the first command queue is less than a threshold value.

8. The memory management method according to claim 1, wherein the method further comprises:
updating a first load value corresponding to the first command queue after the first pending command is pushed to the first command queue.

9. The memory management method according to claim 1, wherein the pending commands comprise the pending commands corresponding to the plurality of memory submodules respectively.

10. A memory storage device, comprising:
a connection interface unit configured to be electrically connected to a host system;
a rewritable non-volatile memory module, wherein the rewritable non-volatile memory module comprises a plurality of memory submodules; and
a memory control circuit unit electrically connected to the connection interface unit and the rewritable non-volatile memory module,
wherein the memory control circuit unit is configured to obtain a plurality of load values of a plurality of command queues corresponding to the plurality of memory submodules respectively,
wherein the memory control circuit unit is configured to select a first command queue from the plurality of command queues according to the plurality of load values, wherein the first command queue corresponds to a first memory submodule, and
wherein the memory control circuit unit is configured to push a first pending command corresponding to the first memory submodule in pending commands to the first command queue.

11. The memory storage device according to claim 10, wherein the operation of the memory control circuit unit obtaining the plurality of load values of the plurality of command queues corresponding to the plurality of memory submodules respectively further comprises:
the memory control circuit unit is further configured to obtain an execution completion time of each command according to a command type of each of the commands in each of the command queues, and sum up the execution completion time of each of the commands as the load value of each of the command queues.

12. The memory storage device according to claim 10, wherein the operation of the memory control circuit unit selecting the first command queue from the plurality of command queues according to the plurality of load values, wherein the first command queue corresponds to the first memory submodule in the plurality of memory submodules further comprises:
the memory control circuit unit is further configured to sort the plurality of load values according to an ascending order of the load values to obtain a sorting result, and
the memory control circuit unit is further configured to select the first command queue from the plurality of command queues according to the sorting result, wherein the first load value corresponding to the first command queue is smallest.

13. The memory storage device according to claim 12, wherein after the operation of the memory control circuit unit selecting the first command queue from the plurality of command queues according to the sorting result,
the memory control circuit unit is further configured to determine whether the first command queue is not full and whether there is the first pending command corresponding to the first command queue in the pending commands;
when the first command queue is not full and there is the first pending command corresponding to the first command queue in the pending commands, the memory control circuit unit is further configured to push the first pending command to the first command queue.

14. The memory storage device according to claim 12, wherein after the operation of the memory control circuit unit selecting the first command queue from the plurality of command queues according to the sorting result,
the memory control circuit unit is further configured to determine whether the first command queue is not full and whether there is the first pending command corresponding to the first command queue in the pending commands,
when the first command queue is full, and/or there is no first pending command corresponding to the first command queue in the pending commands, the memory control circuit unit is further configured to remove the first command queue from the plurality of command queues and remove the first load value corresponding to the first command queue from the plurality of load values.

15. The memory storage device according to claim 13, wherein the operation of the memory control circuit unit determining whether the first command queue is not full and whether there is the first pending command corresponding to the first command queue in the pending commands further comprises:
the memory control circuit unit is further configured to determine whether the first command queue is not full according to whether a number of commands in the first command queue is less than a threshold value.

16. The memory storage device according to claim 14, wherein the operation of the memory control circuit unit determining whether the first command queue is not full and whether there is the first pending command corresponding to the first command queue in the pending commands further comprises:
the memory control circuit unit is further configured to determine whether the first command queue is not full according to whether a number of commands in the first command queue is less than a threshold value.

17. The memory storage device according to claim 10, wherein after the memory control circuit unit pushes the first pending command to the first command queue, the memory control circuit unit is further configured to update a first load value corresponding to the first command queue.

18. The memory storage device according to claim 10, wherein the pending commands comprise the pending commands corresponding to the plurality of memory submodules respectively.
